(19) United States
(12) Patent Application Publication
(10) Pub. No.: US 2024/0334256 A1
(43) Pub. Date: Oct. 3, 2024

(54) SYSTEM AND METHOD FOR CONFIGURING NETWORK SLICES FOR TIME-SENSITIVE NETWORKS

(71) Applicant: General Electric Company, Schenectady, NY (US)

(72) Inventor: Stephen Francis BUSH, Latham, NY (US)

(73) Assignee: General Electric Company, Schenectady, NY (US)

(21) Appl. No.: 18/579,250

(22) PCT Filed: Jul. 15, 2022
(86) PCT No.: PCT/US2022/037367

§ 371 Date: Jan. 12, 2024

Related U.S. Application Data
(60) Provisional application No. 63/222,325, filed on Jul. 15, 2021.

(51) Int. Cl. H04W 28/26; H04W 24/04

(52) U.S. Cl. CPC H04W 28/26; H04W 24/04

(57) ABSTRACT

A system and method obtains time-sensitive network application configuration information of an application communicatively coupled to a 5G network; shares the time-sensitive network application configuration information with a network slice configuration mechanism of the 5G network; determines, by the network slice configuration mechanism, a transmission schedule based on the time-sensitive network application configuration information; reserves an amount of network resources of the 5G network in accordance with the transmission schedule; and facilitates transmission of data from the application via the 5G network in accordance with the transmission schedule.

### CROSS-REFERENCE TO RELATED APPLICATIONS

This application claims priority to U.S. Provisional Patent Application No. 63/222,325, filed Jul. 15, 2021, which is incorporated herein by reference in its entirety. This application is also related to International Patent Application No. PCT/US22/37278, filed Jul. 15, 2022, which is incorporated herein by reference in its entirety.

### TECHNICAL FIELD

The subject matter described herein relates to computerized communication networks, such as time-sensitive networks.

### BACKGROUND

The IEEE 802.1 Time-Sensitive Networking Task Group has created a series of standards that describe how to implement deterministic, scheduled Ethernet frame delivery within an Ethernet network. Time-sensitive networking benefits from advances in time precision and stability to create efficient, deterministic traffic flows in a communication network.

Multiple users may simultaneously use a time-sensitive network for both time-sensitive traffic and non-time-sensitive traffic, and new subscribers may join and leave the network. Reserving too much of the network for each network slice could be costly, but reserving too little could result in poor service to users.

### SUMMARY

In some implementations, a method includes obtaining time-sensitive network application configuration information of an application communicatively coupled to a 5G network; sharing the time-sensitive network application configuration information with a network slice configuration mechanism of the 5G network; determining, by the network slice configuration mechanism, a transmission schedule based on the time-sensitive network application configuration information; reserving an amount of network resources of the 5G network in accordance with the transmission schedule; and facilitating transmission of data from the application via the 5G network in accordance with the transmission schedule.

In some implementations, a system includes one or more processors configured to obtain time-sensitive network application configuration information of an application communicatively coupled to a 5G network; share the time-sensitive network application configuration information with a network slice configuration mechanism of the 5G network; determine, by the network slice configuration mechanism, a transmission schedule based on the time-sensitive network application configuration information; reserve an amount of network resources of the 5G network in accordance with the transmission schedule; and facilitate transmission of data from the application via the 5G network in accordance with the transmission schedule.

### BRIEF DESCRIPTION OF THE DRAWINGS

The present inventive subject matter will be better understood from reading the following description of non-limiting embodiments, with reference to the attached drawings, wherein below:

FIG. 1 is a block diagram depicting a time-sensitive network system in accordance with some implementations.

FIG. 2 is a diagram depicting timing concepts regarding a time-sensitive network system in accordance with some implementations.

FIG. 3 is a diagram of a 5G system 300 integrated with time-sensitive network components providing end-to-end deterministic connectivity in accordance with some implementations.

FIG. 4 is a diagram of an abstraction depicting a configuration of a 5G network slice for time-sensitive network application traffic in accordance with some implementations.

FIG. 5 is a flow diagram illustrating an example process for transmitting time-sensitive network application data over a 5G network using network slicing and time-sensitive network elements in accordance with some implementations.

FIG. 6 is a diagram of a 5G system integrated with time-sensitive network components in accordance with some implementations.

### DETAILED DESCRIPTION

One or more embodiments of the inventive subject matter described herein provide systems and methods that use efficient determinism of time-sensitive networking to increase cybersecurity by examining positive feedback between non-classical physics and time-sensitive networking. The difference of elapsed time that occurs due to relativity is treated by the timing and synchronization standard as a contribution to clock drift of network nodes (e.g., switches) and a time-aware scheduler device of a time-sensitive network is configured relative to a time reference of a grandmaster clock device of the network, but then loses simultaneity with a local relative time reference of the scheduler device.

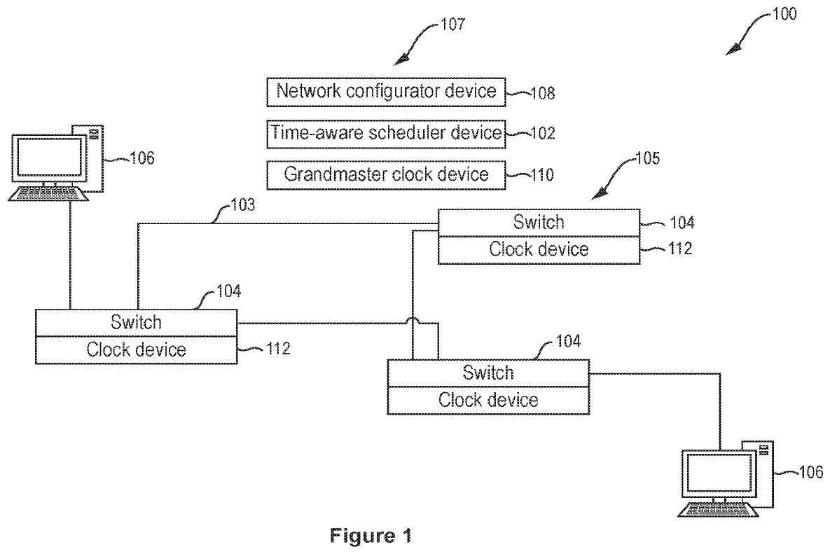

FIG. 1 schematically illustrates one embodiment of a network control system 107 of a time-sensitive network (TSN) system 100. The components shown in FIG. 1 represent hardware circuitry that includes and/or is connected with one or more processors (e.g., one or more microprocessors, field programmable gate arrays, and/or integrated circuits) that operate to perform the functions described herein. The components of the network system 100 can be communicatively coupled with each other by one or more wired and/or wireless connections. Not all connections between the components of the network system 100 are shown herein.

The network system 100 includes several nodes 105 formed of network switches 104 and associated clocks 112 (“clock devices” in FIG. 1). While only a few nodes 105 are shown in FIG. 1, the network system 100 can be formed of many more nodes 105 distributed over a large geographic area. The network system 100 can be an Ethernet network that communicates data signals along, through, or via Ethernet links 103 between devices 106 (e.g., computers, control systems, etc.) through or via the nodes 105. The data signals are communicated as data packets sent between the nodes 105 on a schedule of the network system 100, with the schedule restricted what data signals can be communicated by each of the nodes 105 at different times. For example, different data signals can be communicated at different repeating scheduled time periods based on traffic classifications of the signals. Some signals are classified as time-critical traffic while other signals are classified as best effort traffic. The time-critical traffic can be data signals that need or are required to be communicated at or within designated periods of time to ensure the safe operation of a powered system. The best effort traffic includes data signals that are not required to ensure the safe operation of the powered system, but that are communicated for other purposes (e.g., monitoring operation of components of the powered system).

The control system 107 includes a time-aware scheduler device 102 that enables each interface of a node 105 to transmit an Ethernet frame (e.g., between nodes 105 from one computer device 106 to another device 106) at a prescheduled time, creating deterministic traffic flows while sharing the same media with legacy, best-effort Ethernet traffic. The time-sensitive network 100 has been developed to support hard, real-time applications where delivery of frames of time-critical traffic must meet tight schedules without causing failure, particularly in life-critical industrial control systems. The scheduler device 102 computes a schedule that is installed at each node 105 in the network system 100. This schedule dictates when different types or classification of signals are communicated by the switches 104.

The scheduler device 102 remains synchronized with a grandmaster clock device 110 as clock instability results in unpredictable latency when frames are transmitted. The grandmaster clock device 110 is a clock to which clock devices 112 of the nodes 105 are synchronized. A consequence of accumulated clock drift is that a frame misses a time window for the frame, and must wait for the next window. This can conflict with the next frame requiring the same window.

A centralized network configurator device 108 of the control system 107 is comprised of software and/or hardware that has knowledge of the physical topology of the network 100 as well as desired time-sensitive network traffic flows. The configurator device 108 can be formed from hardware circuitry that is connected with and/or includes one or more processors that determine or otherwise obtain the topology information from the nodes 105 and/or user input. The hardware circuitry and/or processors of the configurator device 108 can be at least partially shared with the hardware circuitry and/or processors of the scheduler device 102.

The topology knowledge of the network system 100 can include locations of nodes 105 (e.g., absolute and/or relative locations), which nodes 105 are directly coupled with other nodes 105, etc. The configurator device 108 can provide this information to the scheduler device 102, which uses the topology information to determine the schedules. The configurator device 108 and/or scheduler device 102 can communicate the schedule to the different nodes 105.

A link layer discovery protocol can be used to exchange the data between the configurator device 108 and the scheduler device 102. The scheduler device 102 communicates with the time-aware systems (e.g., the switches 104 with respective clocks 112) through a network management protocol. The time-aware systems implement a control plane element that forwards the commands from the centralized scheduler device 102 to their respective hardware.

The Timing and Synchronization standard is an enabler for the scheduler device 102. The IEEE 802.1AS (gPTP) standard can be used by the scheduler device 102 to achieve clock synchronization by choosing the grandmaster clock device 110 (e.g., which may be a clock device 112 of one of the switch devices 104), estimating path delays, and compensating for differences in clock rates, thereby periodically pulling clock devices 112 back into alignment with the time that is kept by the grandmaster clock device 110. By pulling the clock devices 112 back into alignment with the grandmaster clock device 112, the use of phase locked loops (PLL) are not used in one embodiment of the network system 100 due to the slow convergence of the loops and because the loops are prone to gain peaking effect.

The clock devices 112 can be measured by the configurator device 108 or the grandmaster clock device 110 periodically or otherwise repeatedly sending generalized time-precision protocol messages (gPTP). The operation consists mainly of comparing the timestamps of the time-precision protocol messages the transmits or receives of local switch device 104 with the timestamps advertised by neighbor switch devices 104. This way, any factors affecting clock drift are correctly detected by the protocol.

A clock device 112 that is suddenly pulled into the past or moved to the future relative to the time kept by the grandmaster clock device 110 can impact the local execution of a time-aware schedule. For example, time-critical traffic may not be communicated by the node 105 that includes the non-synchronized clock device 112 within the scheduled time period for time-critical traffic. The gPTP standard provides a continuous and monotonically increasing clock device 112. Consequently, the scheduler device 102 relies on a clock device 112 that cannot be adjusted and alignment of the clock device 112 is based on logical synchronization, offset from the grand master clock device 110, the link propagation delays with the neighbors, and the clock drifts between the local clock devices 112.

The IEEE 802.1AS standard can be used to detect intrinsic instability and drift of a clock device 112. This drift can occur for a variety of reasons, such as aging of the clock device 112, changes in temperature or extreme temperatures, etc. Relativistic effects from the theory of special and general relativity can be viewed as an extrinsic clock drift and can encompass gravitational and motion time dilation. For example, two clock devices 112 with the same intrinsic parameters would detect no drift, but relativity would cause drift of the time kept by these clock devices 112 from the grandmaster clock device 110.

While general relativity can be rather complicated, gravitational time dilation is straight-forward to apply. In the equation that follows, G is the gravitational constant, M is the mass of the gravitational body in kilograms, R is the radius, or the distance from the center of the mass, in meters, and c is the speed of light in meters per second. Two clock devices 112, one located at a height of 100 m within the Earth's gravitational field and another at an infinite distance from a gravitational field, that is, experiencing no gravitation. Time passes slower within a gravitational field, so the hypothetical clock device 112 located at infinity would be the fastest known clock device 112. When one second has passed for the clock device 112 located at infinity, consider how much time has passed as measured by the clock near Earth. The time at infinity is denoted as T and the time on Earth as T₀. To determine how much time has passed on a clock device 112 at altitude h as compared to the passage of time measured on a clock at the surface of the earth, calculate the time dilation ratio at altitude h and divide this by the time dilation calculated at the surface of the earth, take the square root of the result and then multiply this calculated ratio by the time interval at the surface of the earth and the result of the calculation is the amount of time that has passed on the faster clock by 11 femtoseconds compared to the clock device 112 located higher in the field at altitude h.

$$T = \sqrt{\frac{1 - \frac{2 GM}{( R + h ) {c}^{2}}}{1 - \frac{2 GM}{{Rc}^{2}}}} {T}_{0} \qquad ( 1 )$$

Clock drift induced by gravitational time dilation seems negligible at first glance. Particularly when the speed of transmission is of 1 Gbps. It means that, to make an Ethernet frame of 64 bytes miss its Time-Aware schedule, 672 ns of drift must have elapsed if it is considered that for the 20 bytes of preamble, start frame delimiter, frame check sequence and interframe gap, for a port speed of 1 Gbps. With a difference of height clock of 100 m within the network, such a drift can be obtained within two years of uninterrupted service.

In one embodiment, the schedules provided by the configurator device 108 are relative to grandmaster time and may ignore time dilation. As a result, the schedules lose simultaneity. While neglecting time dilation can be done within an acceptable error margin, the inventive subject matter described herein addresses cases where error on the scheduler devices 102 due to relativity are important. That is, where error caused by clock drift at the nodes 105 can cause time-critical traffic to not be communicated within the scheduled time window for time-critical traffic at one or more of the nodes 105.

Time dilation may be described in physical terms, such as the slowing of time as perceived by one observer compared with another, depending on their relative motion or positions in a gravitational field. In addition, in the context of TSN, time dilation may be described in terms of the stretching of the time it takes to transmit an Ethernet frame due to uncertainty in time synchronization. It is the application guard band that must be applied to the TSN scheduler to ensure that overlapping scheduled flows experience “green lights” all the way through a system without collision, and to ensure the tolerance that the application must allow for frame arrival time jitter is met (which may look like a larger frame given the additional tolerance required).

Several use cases involving pico-satellites or high-speed networks (for example, plane-to-ground transmissions, high speed train communications, smart cities interacting with cars in highways, etc.) subject to significant gravitational gradient are examples where relativity can cause significant drift in the scheduler device 102.

One or more embodiments of the inventive systems and methods described herein examine the impact of time synchronization error upon TSN scheduling by the scheduler device 102 of the control system 107, the impact of time synchronization error on the location, placement, or selection of the grandmaster clock device 110 in the network system 100, and the impact of time synchronization error on bandwidth.

In some embodiments, local guard bands may be defined. The guard bands may dynamically change size based on changes in the time dilation. The guard bands may be determined as time periods and/or network bandwidths in which non-time-critical traffic (e.g., Ethernet frame traffic) cannot be communicated through the node or nodes that are allocated or assigned the guard bands. Throughout this disclosure, non-time-critical traffic may be referred to as best-effort traffic, and time-critical traffic may be referred to as scheduled traffic or priority traffic.

In some embodiments, there are two types of guard bands: TSN guard bands and application guard bands. TSN guard bands may be defined within the TSN itself. In one example, a large best-effort frame may come at a random time and be only partially transmitted when a scheduled TSN frame needs to be transmitted. At this time, the system can either let the best-effort frame finish transmitting, which disrupts the schedule, or preemptively place guard bands to block all potential long pieces of traffic for certain periods of time before scheduled frames need to be sent. Application guard bands are used at the application layer, within the application, which accounts for the fact that even though the system may be using TSN, there may still be some jitter when the traffic arrives. Application-layer guard bands provide extra time periods and/or frequencies to account for this jitter. In other words, from the point of view of the application, guard bands may address jitter that is seen for frames received by the application after they have been transmitted over a TSN transport path.

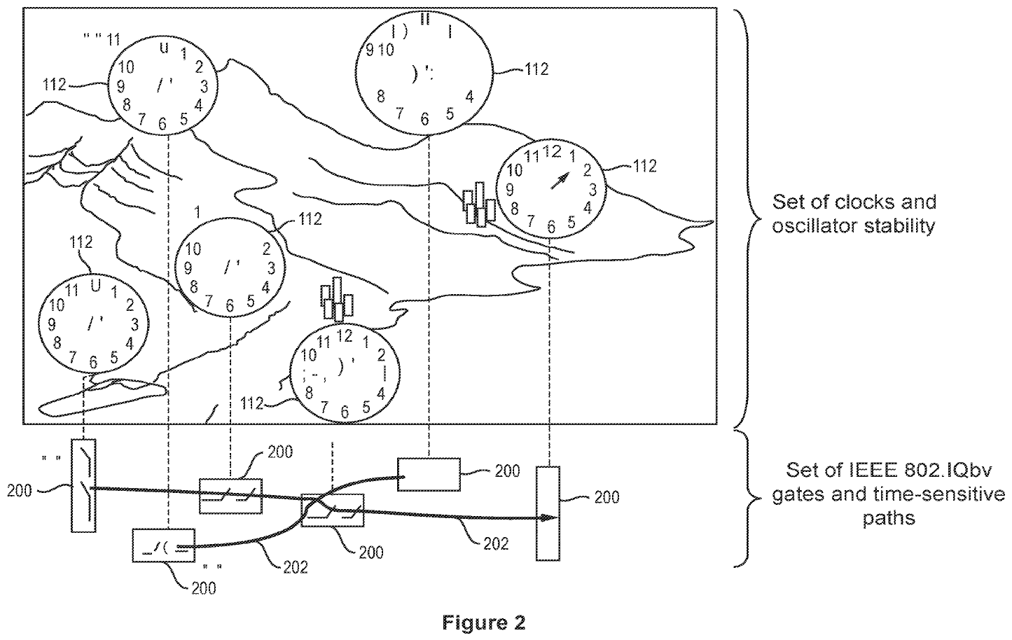

FIG. 2 schematically illustrates a high-level concept behind the analysis described herein. A network of clock devices 112 represented at the top of FIG. 2 are assumed to synchronize imperfectly with one another due to time dilation. The clock devices 112 provide timing for corresponding systems of IEEE 802.1Qbv gates 200 represented at the bottom of FIG. 2. These gates 200 can represent the nodes 105 of the network system 100 shown in FIG. 1. Time-sensitive data flows 202 of data frames between the gates 200 also are shown in FIG. 2. Clock devices 112 may never perfectly synchronize and synchronization error has an impact on the ability of time-sensitive network flows 202 to operate correctly.

Time-sensitive data flows 202 cross diverse local time references and are subject to time dilation that cannot be measured by the gPTP standard. For example, FIG. 2 shows clock devices 112 located in different altitudes, and subject to different relativities. The clock devices 112 located in the mountains, for example, are synchronized to the grand master relative time (e.g., of the grandmaster clock device 110 shown in FIG. 1), but time-sensitive network data flows 202 reaching the clock devices 112 are “accelerating” because of time dilation. The configurator device 108 shown in FIG. 1 can prevent or correct for this acceleration by applying compensation on the configuration of the scheduler device 102. This compensation can occur by determining a guard band to be applied for communication of data flows at one or more of the nodes 105 or gates 200. This guard band can dynamically change as the compensation needed to correct for clock drift changes over time.

To compute the impact of time-sensitive network timing error, the scheduler device 102 computes schedules for network bridges (e.g., switches 104). The scheduler device 102 can use a heuristic approach that is non-deterministic polynomial-time hardness (NP-hard). The schedules can be computed by assuming that individual clock error is independent and normally distributed. The clock devices 112 may drift with a mean μ and have a variance σ. Each gate system 200 can receive or determine time from one of the distributed clocks 112 that is synchronized by the IEEE 802.1AS standard.

Time-sensitive data flow paths are scheduled by the centralized scheduler device 102 assuming perfect synchronization. If clock synchronization fails to achieve a sufficient degree of synchronization, this failure could cause multiple Ethernet frames from different time-sensitive network flows 202 to be simultaneously transmitted on the same link. This would cause an alternate scheduling mechanism to mitigate potential collision and frame loss at the expense of an unnecessary and unpredictable delay in transmission. Thus, in the presence of synchronization error, Ethernet frames in time-sensitive network flows 202 will have a probability of exceeding their maximum, deterministic latency requirement and suffer significant jitter. Under certain synchronization errors, it may even be possible for Ethernet frames to completely miss scheduled transmission window time and catch another open window, thus impacting other time-sensitive network flows 202 that were initially scheduled on different time windows. A guard band can be dynamically calculated and added to the schedules to mitigate clock error and ensure that time-critical traffic is successfully communicated. As such, the better the system is at handling synchronization (as described herein), the smaller the guard bands need to be. Smaller guard bands are preferred because they require less bandwidth. This provides at least one technical effect of the inventive subject matter described herein. Dynamically altering the guard band can ensure that packets (that are needed to be delivered at certain designated times to ensure the same operation of systems using the time-sensitive network) are delivered on time, even with drift of clocks away from the grandmaster clock and/or other differences between the times tracked by the clocks and the master time maintained by the grandmaster clock.

In one embodiment of the inventive subject matter, the scheduler device 102 is provided the details of an Ethernet network system 100 (shown in FIG. 1) and requested time-sensitive network flows 202 and computes schedules for each flow 202. While the scheduler device 102 is designed to operate with real Ethernet networks 100 and manually crafted time-sensitive network flows 202, one component for this analysis is the ability to randomly generate large numbers of time-sensitive network flows 202 in a large, randomly generated Ethernet network 100. Thus, the scheduler device 102 is able to analyze large, complex time-sensitive network schedules in large, complex networks 100.

Random jitter can be unpredictable and is assumed to be Gaussian (e.g. thermal noise). Deterministic jitter can be predictable and bounded (e.g., duty cycle, distortion, and inter-symbol interference). Clock jitter can have a Gaussian distribution. Jitter and parts-per-million (PPM) are related by

$$df = \frac{f}{1 {0}^{6}} PPM ,$$

where f is the center frequency of an oscillator and df is the maximum frequency variation. In one embodiment, the clock devices 112 can be assumed by the scheduler device 102 to have an accuracy of +/−100 PPM with 5 picoseconds of root mean square (RMS) jitter. The RMS error can be related to Gaussian variance by σₙ/\sqrt{2N}, where N is the number of samples (e.g., 10,000) and peak-to-peak period jitter equals +/−3.72 RMS jitter.

One part of the analysis performed by the scheduler device 102 examines how jitter propagates from one clock device 112 to another clock device 112. Random noise can be added by the scheduler device 102, while correlation in noise reduces the purely additive characteristic and creates additional uncertainty. The scheduler device 102 can propagate clock drift and jitter from the grandmaster clock device 110 through all other (e.g., slave) clock devices 112. For example, the other clock devices 112 can be repeatedly synchronized with the grandmaster clock device 110. The model also considers the fact that path delay reduces the ability of the gPTP standard to keep slave clock devices 112 synchronized with the grandmaster clock device 110. The scheduler device 102 implementation enables experimentation with clock accuracy and placement and determines the impact of clock accuracy experimentation on time-sensitive network scheduling.

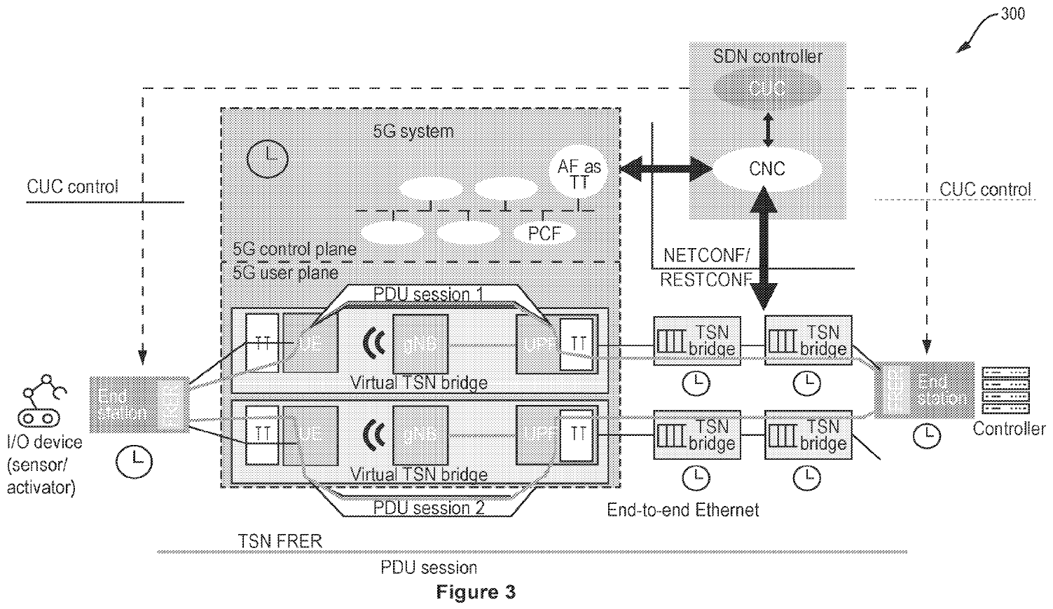

FIG. 3 is a diagram of a 5G system 300 integrated with TSN components providing end-to-end deterministic connectivity. 5G ultra-reliable low-latency communication (URLLC) and TSN features may be combined and integrated to provide deterministic connectivity end to end, such as between input/output (I/O) devices and their controller potentially residing in an edge cloud for industrial automation. Such an integration may include support for both base-bridging features and TSN add-ons.

System 300 illustrates one implementation of a 5G-TSN integration, including some TSN components described above with reference to FIGS. 1 and 2. FIG. 3 depicts a fully centralized configuration model.

The 5G system appears from the rest of the network as a set of TSN bridges-one virtual bridge per User Plane Function (UPF). System 300 includes TSN Translator (TT) functionality for the adaptation of the 5G system to the TSN domain, both for the user plane and the control plane, hiding the 5G system internal procedures from the TSN bridged network.

System 300 provides TSN bridge ingress and egress port operations through the TT functionality. For instance, the TTs support hold and forward functionality for de-jittering. The figure illustrates functionalities using an example of two user equipments (UEs) with two protocol data unit (PDU) sessions supporting two correlated TSN streams for redundancy. But a deployment may only include one physical UE with two PDU sessions using dual-connectivity in RAN. The figure illustrates the case when the 5G system connects an end station to a bridged network; however, the 5G system may also interconnect bridges.

The support for base bridging features described herein is applicable whether the 5G virtual bridges are Class A or Class B capable. The 5G system may support link layer discovery protocol (LLDP) features needed for the control and management of an industrial network, such as for the discovery of the topology and the features of the 5G virtual bridges. The 5G system may also adapt to the loop prevention method applied in the bridged network, which may be fully SDN controlled without any distributed protocol other than LLDP.

Ultra-reliability can be provided end to end by the application of frame replication and elimination for reliability (FRER) over both the TSN and 5G domains. This may require disjoint paths between the FRER end points over both domains, as illustrated in FIG. 3.

A 5G UE can be configured to establish two PDU sessions that are redundant in the user plane over the 5G network. The 3GPP mechanism involves the appropriate selection of CN and RAN nodes (UPFs and 5G base stations (gNBs)), so that the user plane paths of the two PDU sessions are disjoint. The RAN can provide the disjoint user plane paths based on the use of the dual-connectivity feature, where a single UE can send and receive data over the air interface through two RAN nodes.

Additional redundancy—including UE redundancy—is possible for devices that are equipped with multiple UEs. The FRER end points may be outside of the 5G system, which means that 5G does not need to specify FRER functionality itself. Also, the logical architecture does not limit the implementation options, which include the same physical device implementing end station and UE. In some embodiments, such devices may be configured in accordance with IEEE 802.1Qci and/or IEEE 802.1CB in the context of backup slices and redundancy (the redundant TSN flows in a TSN-enabled network slice). In some embodiments, redundancy may take the form of one or more primary flows in an allocated network slice and one or more redundant flows in a backup network slice. In some embodiments, redundancy may take the form of one or more primary flows and one or more redundant flows in the same network slice.

Requirements of a TSN stream may be fulfilled when resource management allocates the network resources for each hop along the whole path. In line with a TSN configuration (e.g., 802.1Qcc), this may be achieved through interactions between the 5G system and the centralized network configuration (CNC) (see FIG. 3). The interface between the 5G system and the CNC allows for the CNC to learn the characteristics of the 5G virtual bridge, and for the 5G system to establish connections with specific parameters based on the information received from the CNC.

Bounded latency may require deterministic delay from 5G as well as QoS alignment between the TSN and 5G domains. 5G can provide a direct wireless hop between components that would otherwise be connected via several hops in a traditional industrial wireline network. An important factor is that 5G can provide deterministic latency, which the CNC can discover together with TSN features supported by the 5G system.

For instance, if a 5G virtual bridge acts as a Class A TSN bridge, then the 5G system may emulate time-controlled packet transmission in line with Scheduled Traffic (e.g., as specified by 802.1Qbv). For the 5G control plane, the TT in the application function (AF) of the 5G system may receive the transmission time information of the TSN traffic classes from the CNC. In the 5G user plane, the TT at the UE and the TT at the UPF can regulate the time-based packet transmission accordingly.

TT internal details may depend on different implementations. For example, a play-out (de-jitter) buffer per traffic class may be implemented. The different TSN traffic classes may be mapped to different 5G QoS Indicators (5QIs) in the AF and the Policy Control Function (PCF) as part of the QoS alignment between the two domains, and the different 5QIs may be treated according to their QoS requirements.

In some implementations, system 300 may be implemented in accordance with network slicing. Network slicing allows a network operator to provide dedicated virtual networks with functionality specific to the service or customer over a common network infrastructure. Thus, network slicing supports numerous and varied services envisaged in time-sensitive networks.

More specifically, network slicing is a form of virtual network architecture using principles behind software defined networking (SDN) and network functions virtualization (NFV) in fixed networks. SDN and NFV deliver network flexibility by allowing traditional network architectures to be partitioned into virtual elements that can be linked (additionally or alternatively through software).

Network slicing allows multiple virtual networks to be created on top of a common shared physical infrastructure. The virtual networks may be customized to meet the specific needs of applications, services, devices, customers or operators.

In the case of time-sensitive networks using the principles described above with reference to network system 100 (e.g., Ethernet, 5G, and so forth), a single physical network may be sliced into multiple virtual networks that can support different radio access networks (RANs), or different service types running across a single RAN. Network slicing may primarily be used to partition the core network, but it may also be implemented in the RAN.

In one network slicing example, an autonomous car may rely on V2X (vehicle-to-anything) communication which requires low latency but not necessarily a high throughput. A streaming service watched while the car is in motion may require a high throughput and is susceptible to latency. Both would be able to be delivered over the same common physical network on virtual network slices to optimize use of the physical network. In another example, a TSN slice in a mobile network may experience high doppler effects (e.g., involving an aircraft) and rapidly changing link latency. In these examples, it may be preferable to characterize and report the jitter of these network slices.

Network slicing maximizes the flexibility of time-sensitive networks, optimizing both the utilization of the infrastructure and the allocation of resources. This enables greater energy and cost efficiencies compared to earlier time-sensitive networks.

Each virtual network (network slice) comprises an independent set of logical network functions that support the requirements of the particular use case, with the term ‘logical’ referring to software.

Each virtual network may be optimized to provide the resources and network topology for the specific service and traffic that will use the slice. Functions such as speed, capacity, connectivity and coverage may be allocated to meet the particular demands of each use case, but functional components may also be shared across different network slices.

Each virtual network may be completely isolated so that no slice can interfere with the traffic in another slice. This lowers the risk of introducing and running new services, and also supports migration because new technologies or architectures can be launched on isolated slices. Network slicing also has a security impact, because if a cyber attack breaches one slice the attack is contained and not able to spread beyond that slice.

Each network slice may be configured with its own network architecture, engineering mechanism, and network provisioning. Each network slice may typically contain management capabilities, which may be controlled by the network operator or the customer, depending on the use case. Each network slice may be independently managed and orchestrated. The user experience of each network slice may be the same as if the slice were a physically separate network.

Network slicing may be optimized for time-sensitive networks employing 5G services. For example, in 5G end-to-end (E2E) autonomous network slicing, different network slices can be created automatically and in an optimized way on a shared RAN, core, and transport network.

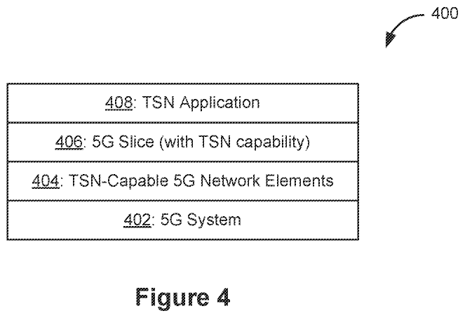

In some embodiments, it may be advantageous for a TSN system as described herein (e.g., with reference to FIGS. 1-3 above and/or FIGS. 4-6 below and corresponding disclosure) to characterize and report jitter in a TSN-implemented slice. In this context, a TSN-enabled network slice may refer to a network slice comprised of one or more TSN flows that support the transport of data for the network slice. Jitter may be characterized for a TSN-enabled network slice as a whole (e.g., through all flows of a slice).

There are several ways to characterize jitter for a TSN-enabled network slice, including best jitter through one of the paths, smallest jitter, maximum jitter through the worst path, and mean and/or variance of jitter through all of the paths. In the following discussion, jitter is characterized using mean and variance. In other embodiments, however, jitter may be characterized by any other means (e.g., including one or more of those noted above).

In some embodiments, jitter accumulates as the sum of root mean square (RMS) values. In other words, jitter for a slice (or for a subset of a slice) can be expressed as the square root of the jitter values along each portion of a path, all summed together. The following equation expresses jitter as X_{RMS}:

$${x}_{RMS} = \sqrt{( \frac{1}{n} ) ( {x}_{1}^{2} + {x}_{2}^{2} + … + {x}_{n}^{2} )} \qquad ( 2 )$$

In equation (2), X_{RMS} is the jitter for one TSN path in a particular slice, which is equal to the square root of the jitter X along each hop in a path having n hops. In some embodiments, a simplifying assumption is made that the sources of jitter (corresponding to each of the n hops) are uncorrelated with one another. Example hops include Ethernet switches, connecting cables, and so forth. This definition of jitter takes into account the time at which the frame came out of the prior adjacent network device until the time at which the frame egresses the current network device (e.g., the time over cable and through the current device). To be clear, the jitter is not the delay, but the variance in the delay. In alternative embodiments, the third moment of delay (i.e., the variance in the jitter, or the variance in the variance of the delay) may be characterized and reported, or the fourth moment of delay (e.g., the variance in the variance in the jitter, or the variance in the variance in the variance of the delay) may be characterized and reported, and so forth.

Upon determining the jitter for X_{RMS}, the mean and variance of all of the paths are reported for the slice jitter. The following equations express the mean (XEslice) and variance (XVslice) of the slice jitter:

$${x}_{Eslice} = E [ {x}_{RMS} ] \qquad ( 3 )$$

X_{Vslice}=Var[x_{RMS}] (4)

In equation (3), XEslice is the expected mean value of jitter X_{RMS} for that slice, and in equation (4), XVslice is the variance in the jitter X_{RMS} for that slice.

Thus, in an example method, a Management and Orchestration (MANO) module first calculates the jitter X_{RMS} for every path in a given slice, then determines the mean XEslice and variance XVslice over all of the paths of the slice, then reports these values to a scheduler module (e.g., 102, FIG. 1) or any other module configured to schedule frames in a TSN slice and/or adjust guard bands based on jitter mean and variance (and/or based on any other definition or characteristic(s) of jitter).

In some embodiments, the module that receives these variance reports (e.g., 102, FIG. 1, or a MANO module) may characterize the slice (e.g., determine what kind of slice it is based on jitter), and/or report how the slice is currently operating (e.g., for management and reporting purposes). These reports may be used in conjunction with best-effort traffic statistics and TSN flow traffic size (e.g., frame length statistics for one or more frames) in order to perform dynamic rescheduling for potentially conflicting flows and/or dynamic guard band length and/or frequency readjustments.

For example, if a TSN schedule is already in place, and a particular gate is scheduled to open at t=5 ms into a cycle and close at t=6 ms into the cycle, this may or may not be long enough for scheduled frames to get through the queue, depending on the timing and size of the scheduled frames. When TSN is running, best-effort traffic is always available and allowed to run over any open queue. Any queue that is open that has best-effort traffic is allowed to transmit and can continue running non-TSN traffic simultaneously with TSN traffic. But if there is a long best-effort frame that takes 2 ms to transmit, and it starts transmitting at t=4 ms, then there will be a collision at t=5 ms since the frame is only halfway transmitted when the gate opens for scheduled traffic at t=5 ms. In this example, these types of collisions can be prevented by making sure all gates are closed prior to 2 ms before opening the TSN gate, or by stopping the long best-effort traffic halfway through its transmission (referred to as TSN frame preemption), which is a not a desired outcome. A properly placed and timed guard band prevents the need for TSN frame preemption.

In addition or as an alternative to best-effort traffic statistics and TSN flow traffic size, jitter mean and variance reports may be used in conjunction with dynamic rescheduling data (e.g., schedules for data flows), individual network device jitter (e.g., jitter caused by network devices such as bridges, routers, switches, hubs, and so forth), and/or indications of whether best-effort traffic is being used and whether it could interfere and cause jitter.

Continuing with the example method, a determination may be made regarding whether the reported jitter is acceptable or not (e.g., whether the jitter meets or does not meet a threshold of acceptability for a given application or a given function associated with an application). This determination may include a determination whether traffic associated with a slice is following a particular schedule after it comes out of the TSN system. If the traffic is not following the schedule (e.g., is falling behind), then the jitter is unacceptable. In some embodiments, if the jitter is unacceptable, the TSN scheduler (e.g., 102, FIG. 1) can reassign a particular TSN path to a different slice. In some embodiments, if the jitter is unacceptable, one or more guard bands may be dynamically changed (e.g., increased in time or changed in frequency). In some embodiments, the amount a guard band has to be lengthened may be directly related to the amount of uncertainty (jitter) regarding when TSN traffic is going to overflow or otherwise have unacceptable timing. Thus, the amount of uncertainty regarding TSN traffic timing can be managed by dynamically rescheduling and/or adjusting guard bands based on the jitter reports and other factors discussed above. For example, an application-layer guard band may be changed (e.g., as part of an aviation system such as a jet engine control system, in which low latency is important).

In some embodiments, the infrastructure provider for a 5G network (the provider who is providing TSN-enabled 5G slices) may provide a TSN-enabled network slice to a TSN application (or a non-TSN application that is jitter-dependent or otherwise time-sensitive) in the form of a negotiation (e.g., a standards-based exchange). The provider may provide mean jitter for the slice (or the expected value of mean jitter for the slice) and variance in jitter for the slice (or the expected value of variance in jitter for the slice). The TSN application may respond (in some instances, before the provider allocates the slice) with a rejection based on a determination that the mean jitter and/or variance in jitter are above respective thresholds of acceptability. The TSN application may respond with a notification requesting or requiring the provider to minimize the mean jitter and/or variance in jitter before allocating the slice. Such a TSN application may require less variance in order to properly function. In response, the provider may reallocate the TSN flows for their slices in order to decrease the mean jitter and/or the variance in jitter for the TSN slice.

In some embodiments, any representation of jitter may be described and reported, including statistical plots, bell curves, Gaussian representations, normal representations, and/or any graphical technique for characterizing or otherwise describing jitter. In some embodiments, histograms of latencies (e.g., collected from samples) may be used to describe jitter statistics. In some embodiments, transmissions of TSN traffic conforming to IEEE 802.1Qbv (regarding gates) and/or IEEE 802.1Qav (regarding leaky bucket throttling mechanisms for TSN) may be used with the jitter reporting and dynamic rescheduling and guard band adjustments described above. In general, any time-sensitive and/or time-aware shaper mechanisms may be used in conjunction with the jitter reporting and dynamic rescheduling and guard band adjustments described above.

In some embodiments, the jitter reporting and dynamic rescheduling and guard band adjustments described above may be used with desegregated TSN, when dividing the 5G system into separately configured TSN blocks, so each block could have its own mean and variance (or other statistics) of jitter. In these embodiments, the X_{RMS} computations described above could be done through the desegregated TSN blocks within the 5G system. As such, each component of the 5G path may be TSN-enabled within the 5G system, where each hop in a given path can be associated with an X_{RMS} jitter calculation from one endpoint of the 5G system to another endpoint, or for just portions of the 5G system (e.g., from one endpoint to a point in the middle). In general, the jitter reporting and dynamic rescheduling and guard band adjustments described above can be used for any TSN flow through a 5G system, regardless of whether the flow is enabling a TSN slice or not.

In some embodiments, reporting the jitter factors as described above (e.g., including mean and/or variance) includes reporting the jitter factors to a MANO module using a TSN YANG module to represent the jitter data. As such, the jitter mean and/or variance of the TSN-enabled slice may be part of the YANG module.

In some embodiments, the White Rabbit Approach (IEEE 1588 High Accuracy Profile) may be used in 5G networks for improved time synchronization. As such, there is a drive toward ever higher time precision and requirements for TSN to be able to handle it by innovating around tighter operating specifications (guard bands, etc.). Thus, the jitter reporting and dynamic rescheduling and guard band adjustments described above can be useful in such applications.

In some embodiments, the jitter reporting and dynamic rescheduling and guard band adjustments described above can be useful in 5G applications using quantum technology (e.g., quantum radio, quantum memory, and so forth), due to the extreme sensitivity and timing requirements of such applications.

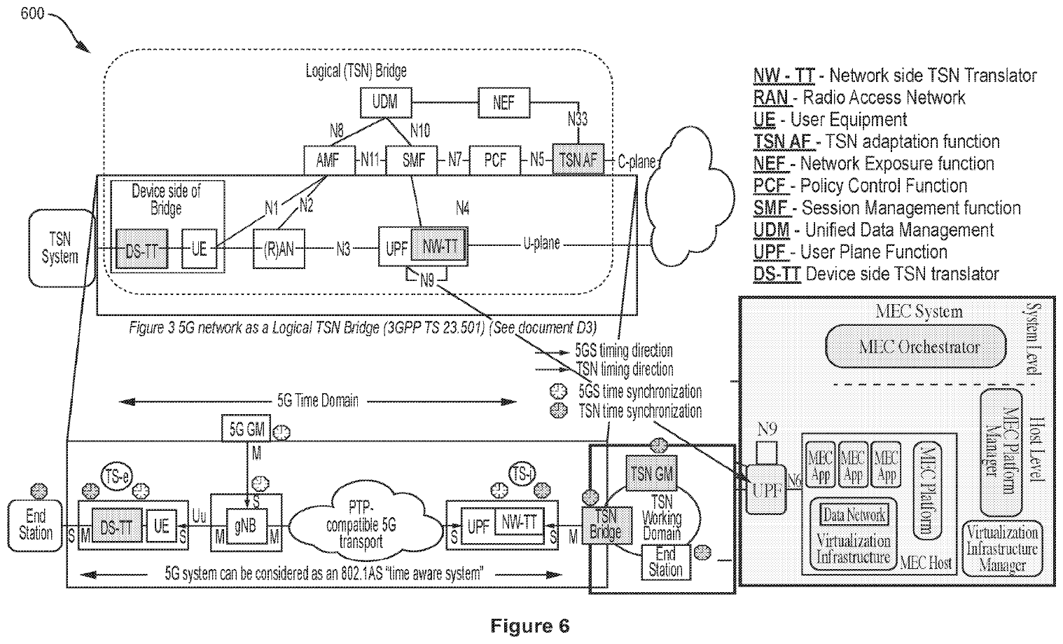

FIG. 6 shows a topology 600 of an exemplary 5G network integrated with TSN and mobile edge computing (MEC) systems. In this example, similar to the example illustrated in FIG. 3, the 5G system (5GS) is integrated with an external network as a logical TSN Bridge under IEEE 802.1Q. This integrated system may support the fully centralized model configuration for TSN as specified in IEEE 802.1Qcc, and support IEEE 802.1Qbv based scheduling. Such an integrated system may be considered an IEEE 802.1AS “time-aware system.” In this system, the 5GS bridge is on a per user-plane-function (UPF) with each UPF supporting multiple protocol data unit (PDU) sessions, which can be mapped to multiple ports on a single UPF. In some implementations, TSN is integrated with or implemented on end systems/stations and core of the 5G system (e.g., TSN for antenna control, MIMO control, etc.).

FIG. 4 is a diagram of an abstraction 400 depicting a configuration of a 5G network slice for TSN application traffic. In some implementations, a 5G system 402 (e.g., corresponding to system 300) includes TSN-capable 5G network elements 404 (e.g., corresponding to TSN bridges, 5G system components, and SDN controller components in FIG. 3). A 5G slice 406 having TSN capability may be used by a TSN application 408 (e.g., an application transmitting and/or receiving data via the 5G system using one or more time-sensitive network protocols).

As described above, network slicing enables virtualized and independent logical networks on the same physical network infrastructure. As such, 5G network slicing enables virtualized and independent logical networks on the same 5G network infrastructure (e.g., system 300). For such a network system 402, each network slice 406 may function as an isolated, end-to-end network tailored to fulfill requirements requested by a particular application 408.

TSN applications 408 may have specific 5G requirements by nature of the TSN protocol suite upon which they reside. Thus, the requirements of the 5G network slice 406 provided for the TSN application 408 can be derived directly from the TSN configuration used by the application (also referred to as TSN application configuration information).

For a given TSN application 408, a TSN configuration associated with the TSN application may be specified by a TSN application function (AF) for connecting the TSN centralized user configuration (CUC)/centralized network controller (CNC) entities and the 5G control plane. A TSN configuration used by the application may include particular values, ranges, or upper or lower thresholds related to requirements for bandwidth, latency, quality of service (QOS), and/or other parameters related to the transmitting/receiving of data associated with execution of the application using the 5G system 402. In some implementations, the TSN configuration information associated with the application may include IEEE 802.1Qbv schedule data.

In some implementations, the TSN application 408 shares its TSN configuration information with a configuration mechanism of the 5G network slice 406 (also referred to as 5G network slice configuration mechanism), in order to ensure that a necessary and sufficient set of virtualized and independent logical network elements (associated with the slice) are properly reserved and configured within the 5G network.

The 5G network slice configuration mechanism may be implemented by or otherwise associated with the TSN Translator (TT) of the 5G system 402. The TT may be configured with information about the user's TSN application, including, e.g., its IEEE 802.1Qbv schedule. The TT may derive information from this schedule regarding the expected transit time through the 5G network 402. Thus, sufficient 5G network resources may be reserved in order to support the desired schedule. In some implementations, if the 5G network cannot support the schedule, the 5G network indicates this to the application.

Scheduling may include complicated analyses for the 5G network. In some implementations, such scheduling may include gNB radio scheduling, fronthaul transport, 5G core network (CN) processing, and another gNB radio. A plurality of users may be simultaneously using this infrastructure for both TSN and non-TSN traffic, and new subscribers may be joining and leaving the network. Reserving too much of a network resource for each network slice could be costly (due to network resources being underused), but reserving too little could result in poor service to customers (due to network resources being overused).

In some implementations, the 5G system 402 provides insight to TSN users on the capability of the network slice 406 via an abstraction that includes the reliability of the TSN network slice. This allows users to determine how to better configure IEEE 802.1CB (redundant TSN flow segments). This also provides users with the ability to ascertain the reliability of their 5G networks, which could be important for applications such as life-critical control applications.

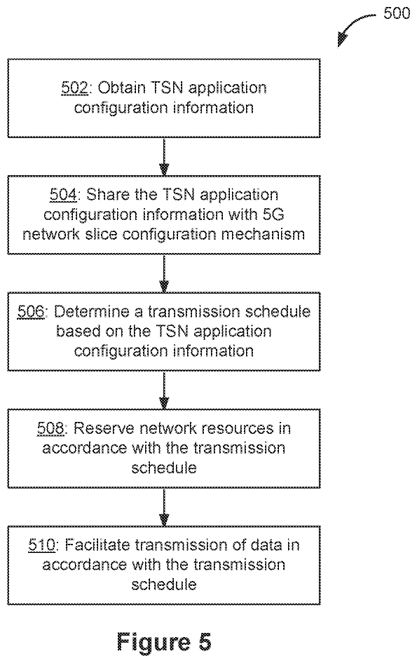

FIG. 5 is a flow diagram illustrating an example process 500 for transmitting time-sensitive network application data over a 5G network using network slicing and time-sensitive network elements. Process 500 is, optionally, governed by instructions that are stored in a computer memory or non-transitory computer readable storage medium and that are executed by one or more processors of the 5G network (e.g., CNC and/or TT in FIG. 3). The computer readable storage medium(s) may include a magnetic or optical disk storage device, solid state storage devices such as Flash memory, or other non-volatile memory device or devices. The instructions stored on the computer readable storage medium(s) may include one or more of: source code, assembly language code, object code, or other instruction format that is interpreted by one or more processors. Some operations in process 500 may be combined and/or the order of some operations may be changed.

In operation 502, a time-sensitive network application that is communicatively coupled to a 5G network obtains (determines) time-sensitive network application configuration information, for sharing with time-sensitive network components of the 5G network. In some implementations, the time-sensitive network application configuration information includes schedule data, such as an IEEE 802.1Qbv schedule.

In operation 504, the application shares (conveys) the time-sensitive network application configuration information with a network slice configuration mechanism of the 5G network. In some implementations, the network slice configuration mechanism is a time-sensitive network translator (TT) as described above with reference to FIG. 3. In some implementations, sharing the time-sensitive network application configuration information with the network slice configuration mechanism includes configuring the network slice configuration mechanism with the schedule data (transmission schedule data).

In operation 506, the network slice configuration mechanism determines a transmission schedule based on the time-sensitive network application configuration information. In some implementations, the network slice configuration mechanism determines an expected network transit time from the time-sensitive network application configuration information (e.g., from the transmission schedule). In one example, a network slice may be shared by an entire company that may have many TSN flows running over it (flow-in-flow). In this example, the network slice is not equal to a single flow, but instead is equal to a set of all flows supporting anything the company may want from its slice. This could include best-effort flows or TSN flows (on top of the TSN-implemented slice). In some embodiments, a TSN-implemented slice reports jitter characteristics (e.g., mean and variance) as discussed above. As such, in some embodiments, the expected network transit time may be at least partially based on the reported jitter characteristics.

In operation 508, one or more time-sensitive network components of the 5G network (or the application) reserves an amount of network resources of the 5G network in accordance with the transmission schedule. In some implementations, reserving an amount of network resources includes ensuring that the transmission of data meets the expected network transit time that was derived from the transmission schedule. In some implementations, reserving an amount of network resources includes reserving sufficient network resources to support the transmission schedule.

In operation 510, one or more time-sensitive network components of the 5G network (or the application) facilitates transmission of data from the application via the 5G network in accordance with the transmission schedule. In some implementations, facilitating transmission of the data from the application includes executing radio scheduling, fronthaul transport, and core network processing of the 5G network.

In some implementations, method 500 further comprises determining network slice reliability data (e.g., providing insight regarding the capability of the network slice via an abstraction that includes the reliability of the network slice) based on a performance metric (e.g., actual transit time, latency, and/or quality of service) corresponding to the transmission of the data from the application via the 5G network, and providing the network slice reliability data to the application (e.g., for output to a user of the application).

Sharing TSN application configuration information with network slice configuration mechanisms as described above enables configuration of 5G network slices specifically for TSN applications, and provides more reliable 5G operation for TSN utilizing the 5G network slicing concept.

As used herein, an element or step recited in the singular and proceeded with the word “a” or “an” should be understood as not excluding plural of said elements or steps, unless such exclusion is explicitly stated. Furthermore, references to “one embodiment” of the presently described subject matter are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the subject matter set forth herein without departing from its scope. While the dimensions and types of materials described herein are intended to define the parameters of the disclosed subject matter, they are by no means limiting and are exemplary embodiments. Many other embodiments will be apparent to those of skill in the art upon reviewing the above description. The scope of the subject matter described herein should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112 (f), unless and until such claim limitations expressly use the phrase “means for” followed by a statement of function void of further structure.

This written description uses examples to disclose several embodiments of the subject matter set forth herein, including the best mode, and also to enable a person of ordinary skill in the art to practice the embodiments of disclosed subject matter, including making and using the devices or systems and performing the methods. The patentable scope of the subject matter described herein is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

1. A method comprising:
obtaining time-sensitive network application configuration information of an application communicatively coupled to a 5G network;
sharing the time-sensitive network application configuration information with a network slice configuration mechanism of the 5G network;
dynamically configuring, by the network slice configuration mechanism, a transmission schedule based on the time-sensitive network application configuration information;
reserving an amount of network resources of the 5G network in accordance with the transmission schedule; and
facilitating transmission of data from the application via the 5G network in accordance with the transmission schedule.

2. The method of claim 1, wherein the time-sensitive network application configuration information includes schedule data.

3. The method of claim 2, wherein the schedule data includes an IEEE 802.1Qbv schedule.

4. The method of claim 1, wherein the network slice configuration mechanism is a time-sensitive network translator.

5. The method of claim 1, wherein sharing the time-sensitive network application configuration information with the network slice configuration mechanism includes configuring the network slice configuration mechanism with schedule data.

6. The method of claim 1, further comprising determining an expected network transit time from the transmission schedule.

7. The method of claim 6, wherein reserving an amount of network resources includes ensuring that the transmission of data meets the expected network transit time.

8. (canceled)

9. (canceled)

10. The method of claim 1, further comprising determining network slice reliability data based on a performance metric corresponding to the transmission of the data from the application via the 5G network, and providing the network slice reliability data to the application.

11. A system comprising one or more processors configured to:
obtain time-sensitive network application configuration information of an application communicatively coupled to a 5G network;
share the time-sensitive network application configuration information with a network slice configuration mechanism of the 5G network;
dynamically configure by the network slice configuration mechanism, a transmission schedule based on the time-sensitive network application configuration information;
reserve an amount of network resources of the 5G network in accordance with the transmission schedule; and
facilitate transmission of data from the application via the 5G network in accordance with the transmission schedule.

12. The system of claim 11, wherein the time-sensitive network application configuration information includes schedule data.

13. The system of claim 12, wherein the schedule data includes an IEEE 802.1Qbv schedule.

14. The system of claim 11, wherein the network slice configuration mechanism is a time-sensitive network translator.

15. The system of claim 11, wherein the one or more processors configured to share the time-sensitive network application configuration information with the network slice configuration mechanism include one or more processors configured to configure the network slice configuration mechanism with schedule data.

16. The system of claim 11, further comprising one or more processors configured to determine an expected network transit time from the transmission schedule.

17. The system of claim 16, wherein the one or more processors configured to reserve an amount of network resources include one or more processors configured to ensure that the transmission of data meets the expected network transit time.

18. (canceled)

19. (canceled)

20. The system of claim 11, further comprising one or more processors configured to determine network slice reliability data based on a performance metric corresponding to the transmission of the data from the application.

21. The method of claim 1, wherein the transmission schedule is dynamically configured based on dynamic guard band configuration.

22. The method of claim 1, wherein the transmission schedule is dynamically configured based on jitter calculation.

23. The system of claim 11, wherein the transmission schedule is dynamically configured based on dynamic guard band configuration.

24. The system of claim 11, wherein the transmission schedule is dynamically configured based on jitter calculation.
